(19) United States
(12) Patent Application Publication
(10) Pub. No.: US 2011/0231072 A1
(43) Pub. Date: Sep. 22, 2011

(54) METHOD FOR CONTROLLING A DRIVETRAIN OF A MOTOR VEHICLE HAVING AN AUTOMATIC CLUTCH

(75) Inventors: Martin ROTH, Rutesheim (DE); Klaus BASTIAN, Neuhausen (DE); Jan-Peter HOFFMEISTER, Leonberg (DE); Michael SCHEU, Ditzingen (DE)

(73) Assignee: Dr. Ing. h.c. F. Porsche Aktiengesellschaft, Stuttgart (DE)

(21) Appl. No.: 13/044,851

(22) Filed: Mar. 10, 2011

(30) Foreign Application Priority Data
Mar. 18, 2010 (DE) 102010011887.7

(51) Int. Cl. F16H 59/14; F16H 59/18

(52) U.S. Cl. 701/58

(57) ABSTRACT

A method for triggering a signal for the separation of the drivetrain input section and drivetrain output section of a motor vehicle having an automatic clutch, characterized in that as a function of the change in clutch torque, and with a time (t_{SEP}) being taken into consideration which can be applied and which indicates the time period required by the system from the triggering of the signal for separation of the clutch until the final separation of the drivetrain input section and drivetrain output section.

### CROSS REFERENCE TO RELATED APPLICATION

This U.S. patent application claims priority to German Patent Application DE 10 2010011887.7, filed Mar. 18, 2010, which is incorporated by reference herein in its entirety.

### FIELD OF THE INVENTION

The invention relates to a method for controlling a drivetrain of a motor vehicle having an automatic clutch, such as is known from WO 02/094601 A2.

### BACKGROUND OF THE INVENTION

WO 02/094601 A2, which is incorporated by reference, relates to a method for controlling a drivetrain having an automatic clutch, with the internal combustion engine being decoupled from the drive wheels in the presence of predetermined operating conditions when the motor vehicle is travelling in order to permit travel without drive. Such travel without drive is referred to as coasting. WO 02/094601 A2 describes coasting as the intentional disengagement of the clutch in overrun operating phases in which neither the accelerator pedal nor the brake pedal is actuated. The disengagement of the clutch is carried out with the aim of saving fuel. In the clutch-disengaged state, the vehicle rolls without losing kinetic energy through the braking action of the internal combustion engine. Here, the internal combustion engine is operated at idle. A precondition for the transition into the coasting operating mode is that the vehicle speed is higher than a limit value and that neither a brake pedal nor an element which determines a supply of fuel (for example an accelerator pedal) is actuated.

DE 198 23 764 A1, which is incorporated by reference, discloses a method for controlling the start of opening of an automatic clutch situated in the drivetrain of a motor vehicle, with at least one variable which is positively related to the rotational speed of the internal combustion engine being measured, and with the rotational speed being calculated therefrom and an actuator which opens the clutch being set in operation if the rotational speed has fallen below a predetermined limit value. Here, the change in rotational speed over time is determined, and the opening value is selected to be higher the further the rotational speed has decreased over time.

DE 10 2008 005 644 A1, which is incorporated by reference, describes a method for saving fuel utilizing a freewheel.

### SUMMARY OF THE INVENTION

The problem on which the present invention was based is that of improving the possibility of saving fuel, and at the same time not permitting any losses in comfort during driving operation.

Said problem is solved by means of the method according to aspects of the invention, in which the decoupling of the transmission and therefore the separation of the drivetrain input section from the drivetrain output section is carried out so precisely in terms of time that the motor vehicle does not enter into overrun operation.

The present invention has the advantage that, when there is no demand for power, the clutch is open and therefore the drivetrain input section and drivetrain output section are separated. For this purpose, the accelerator pedal position is detected and, when the driver is not depressing the accelerator pedal, a corresponding signal “activate the coasting mode” is generated in the transmission control unit, such that a corresponding actuating signal is then directly output to the clutch in order to separate the drivetrain input section and drivetrain output section.

A further advantage of the solution according to aspects of the invention is that, to realize a high level of driving comfort, the driver does not sense any jerk during the disengagement and re-engagement of the drivetrain input section and drivetrain output section. This is the case if the clutch torque transmitted by the transmission at the time of opening of the clutch is approximately zero.

The present invention therefore has the advantage that, in the coasting mode, the drive input unit is separated from the drive output unit by opening the clutch, without energy being lost in an overrun mode, and as a result of the corresponding actuation during the engagement and disengagement, no jerk is perceptible to the driver, and therefore a high level of driving comfort is ensured.

### BRIEF DESCRIPTION OF THE DRAWING FIGURES

The invention is best understood from the following detailed description when read in connection with the accompanying drawings. Included in the drawings is the following figures:

FIG. 1 shows a basic design for carrying out the method,

FIG. 2 shows a diagram of the different torques at the clutch over time, and

FIG. 3 shows a diagram of the engine rotational speed over time.

### DETAILED DESCRIPTION OF THE INVENTION

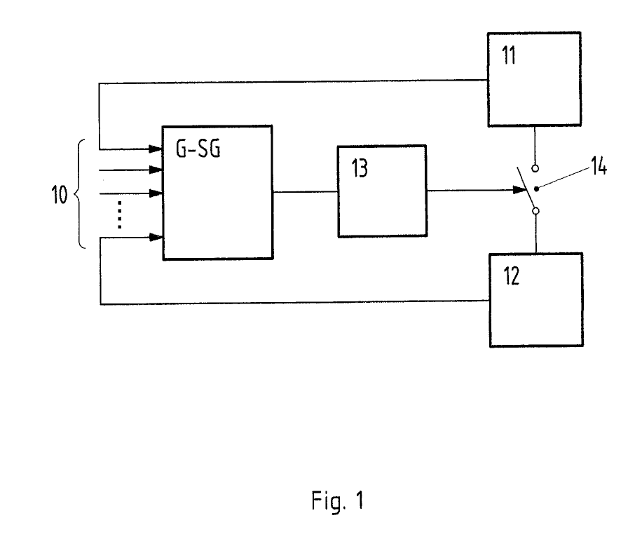

FIG. 1 illustrates in a simplified manner the basic design of the components according to aspects of the invention, with a transmission control unit (G-SG) being supplied with various input variables such as for example rotational speed n, accelerator pedal position, temperature and characteristic variables of the drivetrain input section 11 and of the drivetrain output section 12. In FIG. 1, all the input variables are provided symbolically with the reference numeral 10.

If the accelerator pedal position indicates that the driver is not demanding power, then the process “activate coasting” takes place in the transmission control unit. In the transmission control unit, the optimum time for the separation of the drivetrain input zo section and drivetrain output section is then calculated, and a corresponding actuating signal is output to the clutch 13, which then separates the drivetrain input section 11 and drivetrain output section 12 for the coasting process. In FIG. 1, this is depicted symbolically by the switch 14. When the switch 14 is open, no power is transmitted from the drive input unit to the drive output unit.

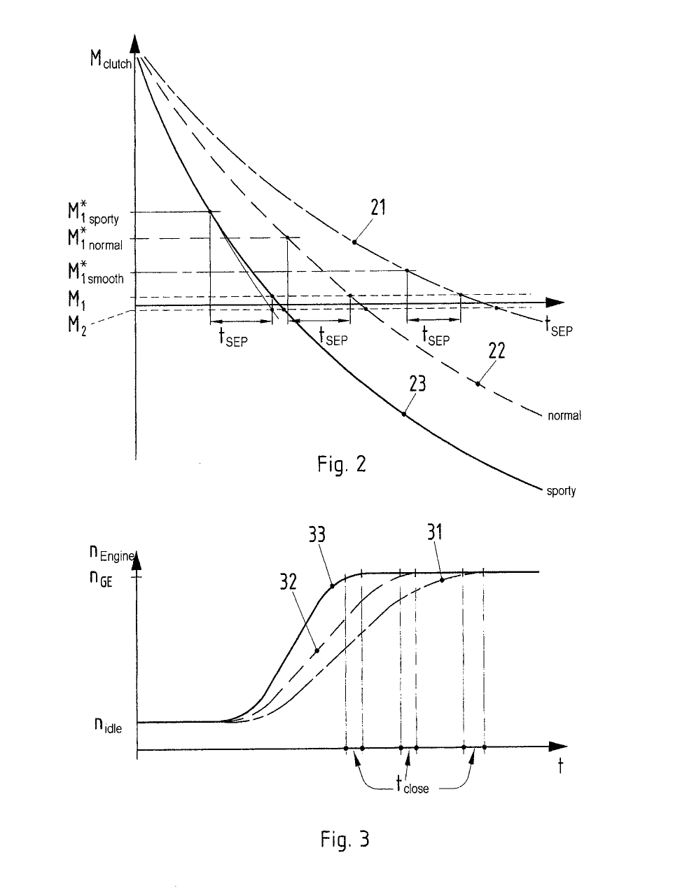

Below, the aspects of the invention will be explained on the basis of FIG. 2. FIG. 2 shows a diagram over time, with the different curves 21, 22 and 23 illustrated here representing different rates of change in the accelerator pedal position.

The change in the accelerator pedal position is made by the driver. On account of the different driving behaviors, in the solution according to aspects of the invention, a distinction is made between a sporty, a normal and a smooth driving behavior.

Therefore, the following rates of change in accelerator pedal position are illustrated in FIG. 2: smooth 21, normal 22 and sporty 23.

The accelerator pedal position and therefore the rate of change in accelerator pedal 35 position is measured in the transmission control unit G-SG and forms the basis for the determination of the time of initiation of the coasting mode.

The time between the measurement and processing of the input variables 10 in the transmission control unit and the output of the signal and the opening of the clutch for a separation of the drivetrain input section and drivetrain output section is substantially always constant regardless of the driving behavior, and is referred to hereinafter as the separating time t_{SEP}. These separating times t_{SEP} are illustrated in FIG. 2 for the curves 21, 22 and 23.

To avoid energy losses, it must be ensured that the motor vehicle does not enter into the overrun mode. Therefore, the separation of the drivetrain input section and drivetrain output section must take place before the clutch torque M_{Clutch} assumes a negative value.

On account of the different curve profiles of the clutch torque for different rates of change in the accelerator pedal position, and the approximately constant separating time, it is necessary, when the conditions for the coasting mode are present, for the signal for separation of the drivetrain input section and drivetrain output section to be output to the clutch significantly earlier if the change in accelerator pedal position takes place quickly (sporty 23) than if a slow change in the accelerator pedal position (smooth 21) takes place.

Ideally, the actual separation of the drivetrain input section and drivetrain output section takes place in a region in which the clutch torque is approximately zero.

On account of the different curve profiles of the torques for different rates of change of accelerator pedal position, said rate of change of accelerator pedal position must correspondingly be taken into consideration when determining the time for opening the clutch.

When the coasting conditions are present, the length of time it will take until the clutch torque has reached the desired value of 0 is precalculated. This precalculated time is combined with the time t_{SEP} which can be read out from a characteristic map, so that the signal for separation of the clutch is output such that the “clutch open” signal to the actuating element 15 takes place when the torque in the drivetrain input section is approximately zero.

Said signal is defined such that the torque in the drivetrain output section reduced by the first derivative multiplied by the time t_{sEp} is less than or equal to a predefinable limit value 1. This yields the following relationships:

$$\begin{matrix}{M}_{Clutch} = {M}_{Engine} - {\overline{ω}}_{Engine} \cdot {J}_{Engine} \\ = ( {M}_{Wheel} + {\overline{ω}}_{Engine} \cdot {J}_{Engine} ) 1 / {J}_{Transmission}\end{matrix}$$

The control unit has stored in it different characteristic curves for the time t_{SEP} which are determined by application. When the coasting conditions are present, the corresponding variable t_{SEP} is then read out from said characteristic map, and the optimum time for outputting the separating signal for the clutch is determined by means of the precalculation of the engine torque as a function of further conditions which are likewise stored in the control unit, such as for example the moment of inertia of the engine.

It is self-evident that the characteristic variables stored here are merely an example, and in the situation in which further variables must be taken into consideration, for example if the air-conditioning system of a vehicle is switched on, said characteristic variables are incorporated jointly in the calculation.

Finally, it should be stated that the re-engagement, that is to say the coupling of the drivetrain input section to the drivetrain output section, takes place analogously to the disengagement. The methods are applied analogously, such that, depending on the clutch closing time, the engine run-up is graded as sporty to comfortable or smooth. The aim is an end of closing at the synchronous rotational speed. Depending on the rotational speed gradient (curve profile of the engine run-up), the closing with the predicted closing time must be initiated at the correct time. The closing time is a value zo which is dependent on the operating point of the engine and which varies according to the clutch state. FIG. 3 illustrates the increase in engine rotational speed proceeding from the idle rotational speed n_{idle}. The three curves 31, 32, 33 represent the different driving behaviors sporty 33, normal 32, smooth 31, which have been defined already during the separation of the drivetrain input section from the drivetrain output section. On account of the different rotational speed profiles and the substantially constant closing time t_{close}, the outputting of the clutch signal takes place at different times.

1.-7. (canceled)

8. A method for controlling a drivetrain of a motor vehicle having an automatic clutch which generates a signal for separation of a drivetrain input section and a drivetrain output section of a motor vehicle, said method comprising the step of:
outputting the signal for separation of the drivetrain input section and drivetrain output section as a function of (i) a change in clutch torque, and (ii) a time (t_{SEP}) which indicates a time period from triggering of the signal for separation of the clutch until final separation of the drivetrain input section and drivetrain output section.

9. The method as claimed in claim 8, wherein the time (t_{SEP}) is determined by application for different operating points.

10. The method as claimed in claim 8, wherein a signal for activating a coasting process is output only if a brake of the motor vehicle is not applied and no system veto is present.

11. The method as claimed in claim 8, wherein a control unit of the vehicle has stored in it different curve profiles for the clutch torque during a change in accelerator pedal position, which curve profiles correspond to different driving behaviors and driving states.

12. The method as claimed in claim 11, wherein a distinction is made at least between the different driving behaviors of smooth, normal and sporty.

13. The method as claimed in claim 8, wherein the torques in the drivetrain input section and in the drivetrain output section at the time of separation of the drivetrain input section and drivetrain output section are approximately equal.

14. The method as claimed in claim 8, wherein the torque transmitted by the clutch at the time of the opening of the clutch is approximately zero.
